(19) United States
(12) Patent Application Publication
(10) Pub. No.: US 2013/0216984 A1
(43) Pub. Date: Aug. 22, 2013

(54) LEARNING ESTIMATION TOOL

(71) Applicants: Cheryl A. Cantrell, Belleville, IL (US); Nancy J. Burns, Fort Myers, FL (US); Jennifer R. Gates, Yorktown, VA (US)

(72) Inventors: Cheryl A. Cantrell, Belleville, IL (US); Nancy J. Burns, Fort Myers, FL (US); Jennifer R. Gates, Yorktown, VA (US)

(73) Assignee: Bank of America, Charlotte, NC (US)

(21) Appl. No.: 13/398,499

(22) Filed: Feb. 16, 2012

(51) Int. Cl. G09B 19/00

(52) U.S. Cl. 434/219

(57) ABSTRACT

Apparatus for determining a cost of designing and developing a teaching method to train a group of employees. The apparatus may include a receiver that receives information relating to a first response selected from a first group of predetermined responses. The first group of predetermined responses may relate to responses to a first question. The apparatus may also include a processor configured to determine, based on the received first response, the amount of time necessary to design and develop the teaching method and to convert the amount of time into a dollar value. The receiver may also receive information relating to a second response selected from a second group of predetermined responses. The second group of predetermined responses may relate to responses to a second question. The processor may also be configured to adjust, based on the received second response, the dollar value associated with the amount of time necessary to design and develop the teaching method.

### FIELD OF TECHNOLOGY

This invention relates to a tool for use in calculating a cost associated with a business-related decision.

### BACKGROUND OF THE DISCLOSURE

Many businesses periodically train groups of employees. These businesses train employees with the purpose of familiarizing them with new skills, business protocols and/or government regulations.

When a business makes an internal decision to train a group of employees, it must calculate a cost associated with the employee training. Typically, each business associate assisting in the determination analyzes and prioritizes relevant information differently. This is undesirable at least because different approaches to calculating the cost of training employees may result in inconsistent business policies and decisioning.

It would be desirable, therefore, to provide an automated system that assists business associates in making informed decisions using a consistent and systematic process for calculating the cost of training employees.

### SUMMARY OF THE DISCLOSURE

A method for projecting a cost of designing and developing a teaching method to train a group of employees. The method may include using a receiver to receive information relating to a response selected from a group of predetermined responses. The group of predetermined responses may relate to a question. The method may also include using a processor to determine, based on the received response, an amount of time necessary to design and develop the teaching method. The method may further include using the processor to convert that amount of time necessary to design and develop the teaching method into a dollar value.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2 shows a graphical user interface that may be used in accordance with the systems and methods of the invention;

FIG. 3 shows another graphical user interface that may be used in accordance with the systems and methods of the invention;

FIG. 4. shows yet another graphical user interface that may be used in accordance with the systems and methods of the invention;

FIG. 5 shows yet another graphical user interface that may be used in accordance with the systems and methods of the invention;

FIG. 6 shows yet another graphical user interface that may be used in accordance with the systems and methods of the invention;

FIG. 7 shows yet another graphical user interface that may be used in accordance with the systems and methods of the invention;

FIG. 8 shows yet another graphical user interface that may be used in accordance with the systems and methods of the invention; and

FIG. 9 shows yet another graphical user interface that may be used in accordance with the systems and methods of the invention.

### DETAILED DESCRIPTION OF THE DISCLOSURE

The systems and methods of the invention relate to assisting a business in calculating a cost associated with training employees. The invention may include a learning estimation tool. The learning estimation tool may calculate a cost associated with designing and developing one or more learning solutions to train business employees.

For the purposes of this application, a learning solution may relate to a teaching method, teaching technique, system and/or process appropriate for educating a group of employees. The learning solution may familiarize the employees with one or more new skills, business protocols, government regulations and/or any other suitable information.

Exemplary learning solutions include instructor led training, coach based training, structured on the job training, virtual instructor led training, web based training, simulation, case study, job aid, quick reference card, self-study, huddle, video presentation, narrated video presentation, instructional website and/or mobile web-based training. Exemplary learning solutions may also include assessments, EPS (electronic performance support) curriculum manager, EPS decision wizard, EPS iTour, EPS tell-me-tool and/or a learning map.

The learning estimation tool may include one or more Excel™ spreadsheets, Word™ documents and/or any other suitable electronic documents. In some embodiments, the learning estimation tool may be downloaded onto a personal computer using a CD, USB, or a download button included on a Web Page. Alternatively, the learning estimation tool may be accessed online via one or more Web Pages. Internet access to the learning estimation tool may be password-encoded.

The learning estimation tool may include an Estimation Wizard Overview and Instructions Homepage (referred to hereinafter as a “Homepage”). The Homepage may include instructions relating to the usage of the learning estimation tool. In some embodiments, the learning estimation tool may include two separate groups of tabs. The Homepage may include selectable buttons that, when selected, either display or hide one or more of the tabs included in each of the groups of tabs.

The first group of tabs included in the learning estimation tool may be Business Impact (referred to hereinafter as “BI”) Tabs. The BI Tabs may be used by one or more business employees when calculating a cost associated with training employees. An exemplary business employee that may use the BI tabs may be a Design Consultant and/or a Learning Consultant (referred to hereinafter as an “LC”). It should be noted that, for the purposes of the application, a BI Tab may relate to a graphical user interface displayed when a BI Tab included in the learning estimation tool is selected.

The BI Tabs may include a BI Summary Tab and BI Component Tabs. The BI Summary Tab may include input fields relating to a project name and a number of associates to be trained. The BI Summary Tab may additionally include multiple fields. The multiple fields may be automatically populated with data input into the BI Component Tabs and/or data calculated by the BI Component Tabs.

One or more of the BI Component Tabs may include a drop-down list that, when selected, displays multiple learning solutions. Upon receipt of information relating to the selection of a learning solution, a BI Component Tab may display multiple questions relating to the selected learning solution. The multiple questions displayed may be in addition to questions displayed in the BI Component Tab before the selection of the learning solution.

The BI Component Tab may additionally display multiple input fields substantially adjacent to the displayed questions. These input fields may be configured to receive answers to the substantially adjacent questions. The answers may be input into the input fields by selecting an answer from a drop-down list or by manually entering the answer using a keyboard. It should be noted that, in some embodiments, the receipt of an answer to a question by a BI Component Tab may prompt the BI Component Tab to display additional questions. It should additionally be noted that input fields not associated with a displayed question may be protected input fields—i.e. input fields that are configured not to receive any input.

The input fields included in the BI Tabs may be configured to receive input from one or more business associates. For the purposes of this application, the input fields in the BI Tabs are described as being completed by the LC, but it should be noted that any business associate(s) may input information into the input fields.

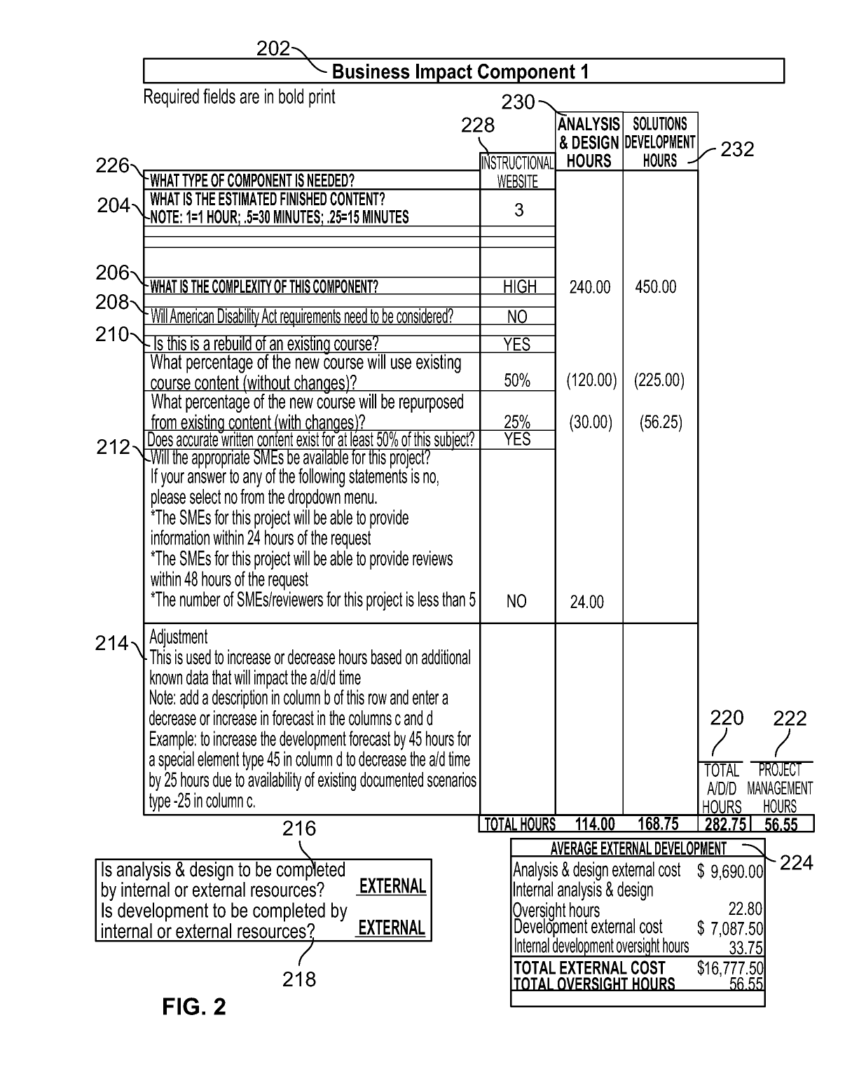

A BI Component Tab may receive a selection relating to a learning solution and information relating to answers to displayed questions. The BI Component Tab may use the information relating to the answers to calculate a number of hours that are required to design and develop the selected learning solution. The BI Component Tab may subsequently use these hours to calculate an expected cost associated with the designing and developing of the selected learning solution. Exemplary hours and costs calculated by the BI Component Tab are included in FIGS. 2-4 and described in the portion of the specification corresponding thereto.

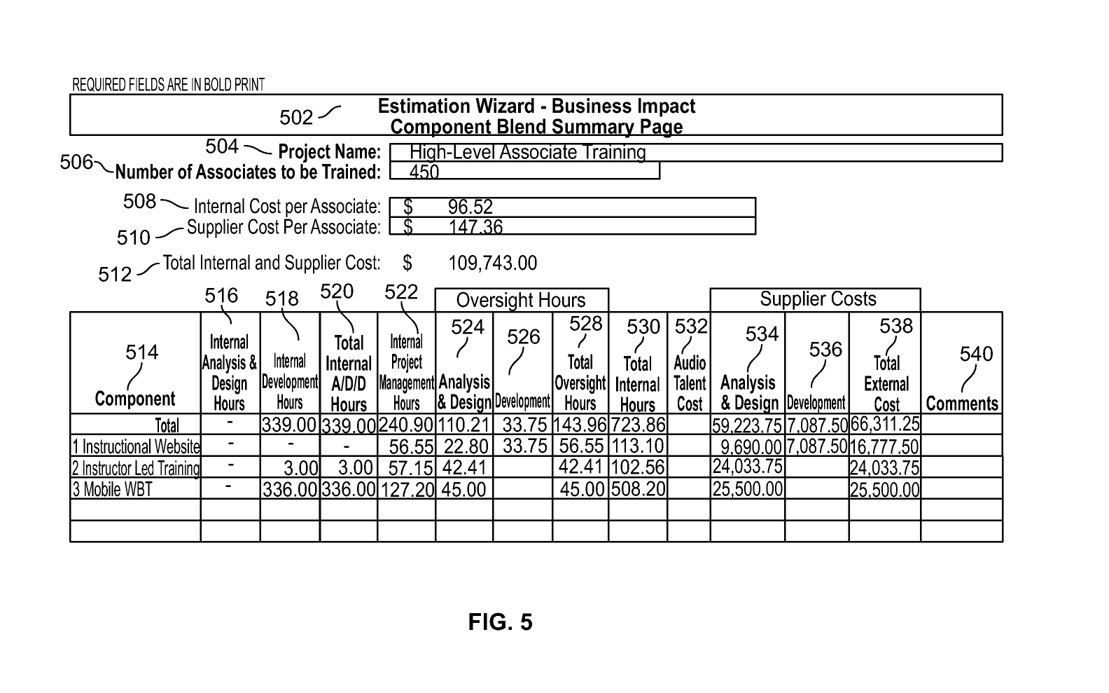

The learning estimation tool may use information input into the input fields included in the BI Component Tabs and/or information calculated by the BI Component Tabs to populate fields included in the BI Summary Tab. For example, costs relating to the design and development of multiple learning solutions that are calculated by BI Component Tabs may be imported and displayed in the BI Summary Tab. An exemplary BI Summary Tab is displayed in FIG. 5 and described in the portion of the specification corresponding thereto.

The BI Summary Tab may be used to provide a high-level estimate for analysis, design and development of a learning solution. The business agreement may be presented to one or more third parties during contract negotiations. The third party may be a third party that collaborates with the business for training business employees, a consulting firm that analyzes and designs education programs and/or any other suitable third party. Exemplary third parties that may collaborate with the business include Design Consultants, Business Partners, Learning Consultants, Metrics Partners and Project Managers.

The BI Component Tabs and BI Summary Tab may be saved. At a later point in time, the BI Component Tabs and BI Summary Tab may be updated as the LC and/or other business associates continue to scope the project and learn additional information. Upon completion of project scoping, a second phase of project analysis may commence. This second phase of project analysis may include using the second group of tabs included in the learning estimation tool.

The second group of tabs included in the learning estimation tool may be Analysis Tabs. The Analysis Tabs may include an Analysis Summary Tab and Analysis Component Tabs. The Analysis Summary Tab and the Analysis Component Tabs may be used by one or more business associates during the analysis of the results included in the BI Summary Tab and the BI Component Tabs. For the purposes of this application, the input fields included in the Analysis Tabs are described as being modified by an Instructional Designer (referred to hereinafter as an “ID”), but it should be noted that any business associate(s) may input information into the input fields included in the Analysis Tabs. It should also be noted that an Analysis Tab may relate to a graphical user interface displayed when an Analysis tab included in the learning estimation tool is selected.

The Analysis Summary Tab may include input fields relating to a project name and a number of associates to be trained. The Analysis Summary Tab may additionally include multiple fields. The multiple fields may be automatically populated with data included in the Analysis Component Tabs and/or data calculated by the Analysis Component Tabs.

The Analysis Component Tabs may be initially populated with questions and answers included in the BI Component Tabs. The ID may subsequently change information in the Analysis Tabs that was imported from the BI Component Tabs. For example, the ID may select an answer to a displayed question that differs from an answer selected by the LC. The ID may also modify a learning solution selected by the LC. For example, the ID may change the selected learning solution to a different learning solution. The ID may additionally select a learning solution not identified by the LC in an Analysis Component Tab that has not yet been populated with data by the LC. It should be noted that in the event that the ID modifies information included in the Analysis Tabs that was imported from the BI Tabs, the information in the corresponding BI Tabs may remain the same.

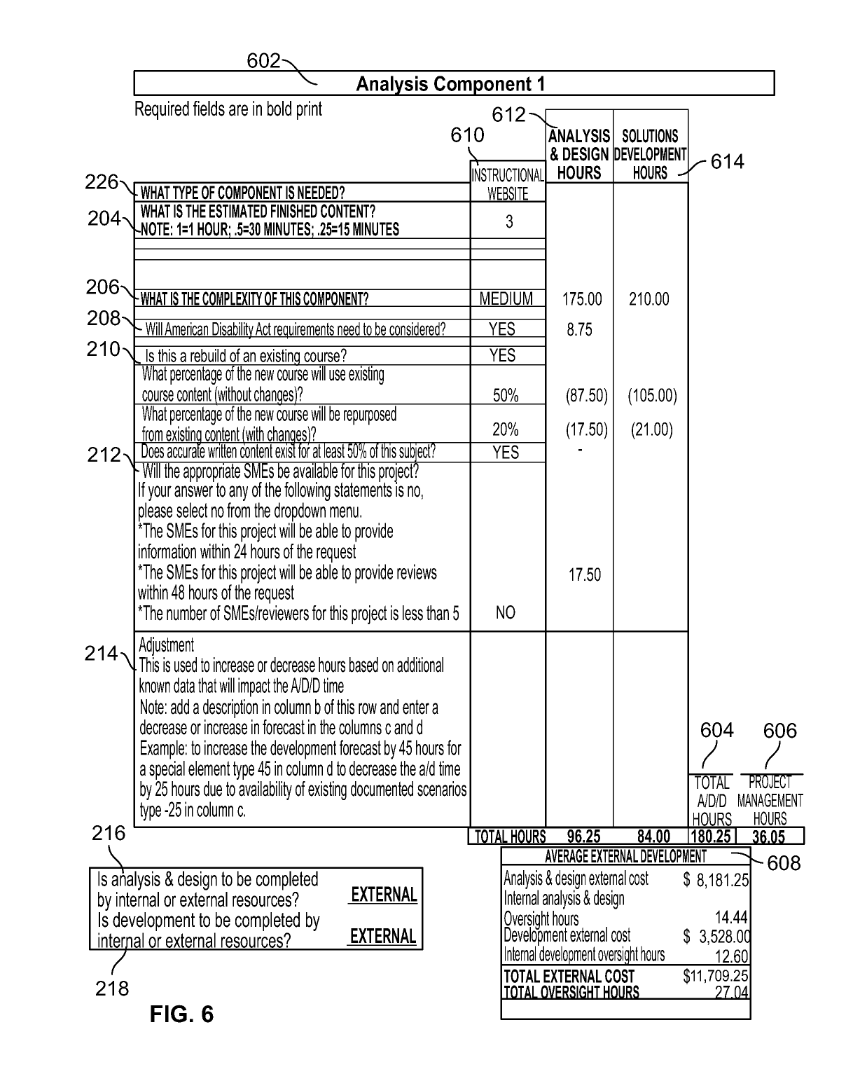

The Analysis Component Tab may use the information input into the multiple input fields to calculate a number of hours that will be required to design and develop the learning solution selected. The Analysis Component Tab may also use the input information to calculate an expected cost associated with designing and developing the learning solution selected. In the event that the ID changes information input into an Analysis Component Tab, the Analysis Component Tab may subsequently recalculate the number of hours required to design and develop the learning solution. The Analysis Component Tab may also recalculate an expected cost associated with designing and developing the learning solution. Exemplary hours and costs calculated by the Analysis Component Tabs are included in FIGS. 6-8 and described in the portion of the specification corresponding thereto.

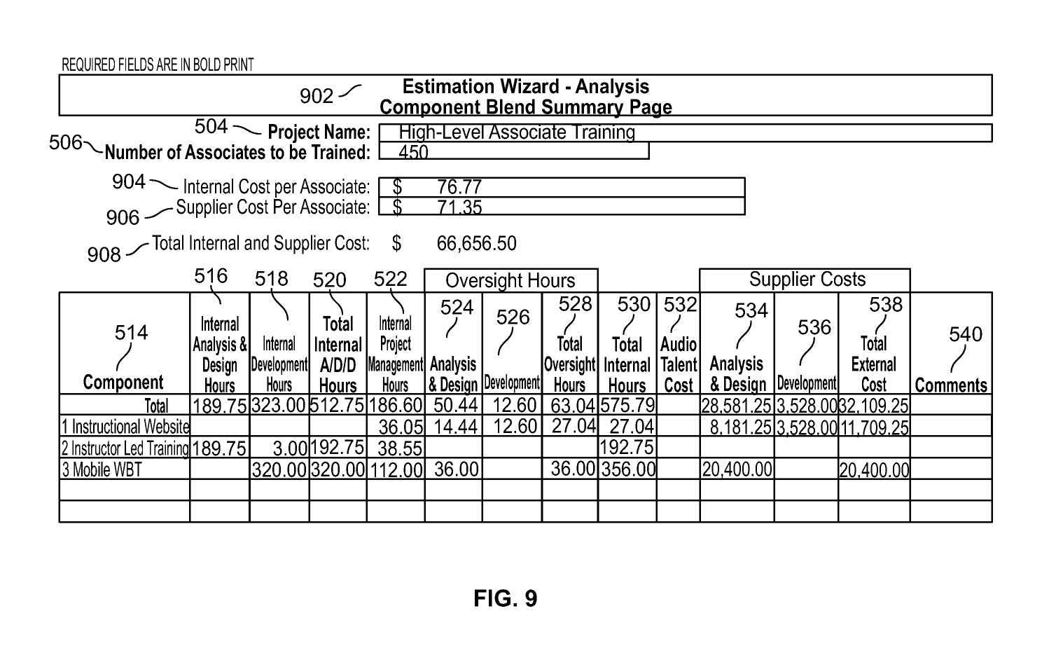

The learning estimation tool may use information input into the input fields included in the Analysis Component Tabs to populate fields included in the Analysis Summary Tab. An exemplary Analysis Summary Tab is displayed in FIG. 9 and described in the portion of the specification corresponding thereto.

It should be noted that the Analysis Component Tabs and the Analysis Summary Tab may be saved. At a later point in time, the Analysis Component Tabs and the Analysis Summary Tab may be updated as the ID and/or other business associates continue to analyze the project and learn additional information.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, the learning estimation tool may be embodied as a method, a data processing system, or a computer program product. Accordingly, the learning estimation tool may take the form of an entirely hardware embodiment, an entirely software embodiment or an embodiment combining software and hardware aspects.

Furthermore, the learning estimation tool may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that the learning estimation tool is embodied at least partially in hardware, the learning estimation tool may include one or more databases, receivers, transmitters, processors, modules including hardware and/or any other suitable hardware. Furthermore, the operations executed by the learning estimation tool may be performed by the one or more databases, receivers, transmitters, processors and/or modules including hardware.

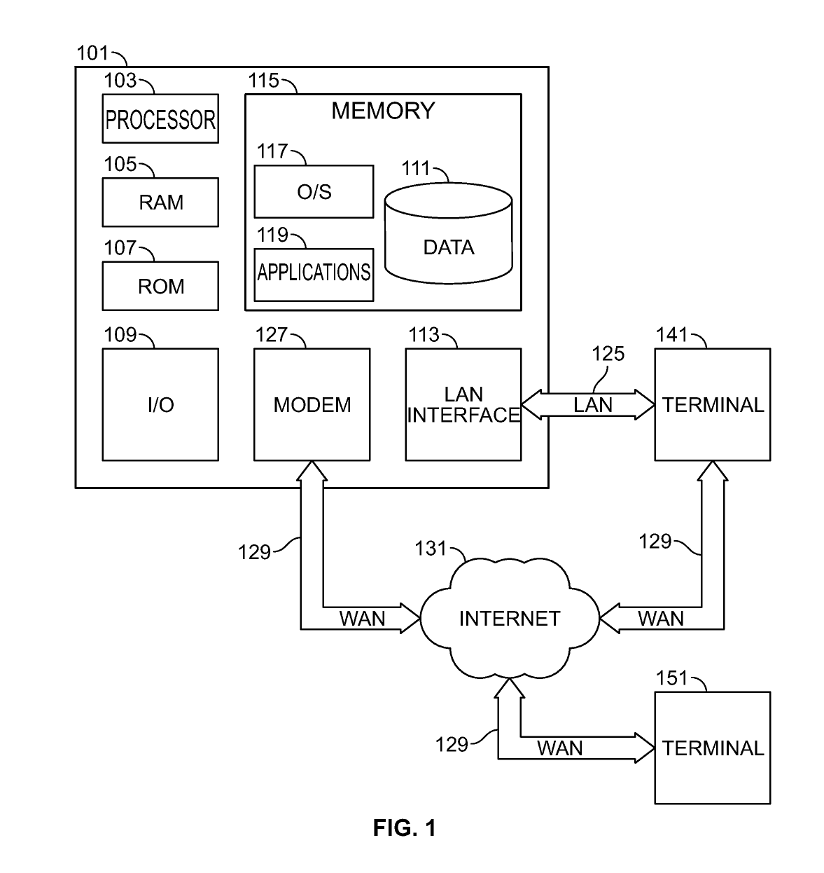

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternatively, some or all of server 101 computer executable instructions may be embodied in hardware or firmware (not shown). As described in detail below, database 111 may provide storage for information input into the learning estimation tool.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by the LC and the ID to access and input information into the learning estimation tool. Information input into the learning estimation tool may be stored in memory 115. The input information may be processed by an application such as one of applications 119.

FIG. 2 shows an illustrative graphical user interface (“GUI”) that may be used in accordance with the systems and methods of the invention. The GUI displayed in FIG. 2 (referred to hereinafter as “GUI 200”) may be displayed in response to the selection of a BI Component Tab included in the learning estimation tool in accordance with the systems and methods of the invention.

GUI 200 may include header “Business Impact Component 1” 202. GUI 200 may additionally include question 226 “What Type of Component Is Needed?” It should be noted that, for the purposes of this application, the term “component” may be used interchangeably with the term “learning solution.” Selectable input field 228 may include a drop-down list of multiple learning solutions that is displayed when input field 228 is selected. In GUI 200, a LC has selected the learning solution “Instructional Website.” It should be noted that, upon selection of the learning solution, GUI 200 may subsequently display questions 204-212.

GUI 200 may display questions 204-212. These questions include “what is the estimated finished content” 204, “what is the complexity of the component” 206, “will American Disability Act requirements need to be considered” 208, “is this a rebuild of an existing course” 210 and “will the appropriate SMEs be available for the project” 212.

GUI 200 may additionally display answers selected by the LC to the displayed questions 204-212. It should be noted that the answers may be selected from a drop-down list displayed and/or manually input by the LC using a keyboard. It should additionally be noted that, in the event that the LC selects “yes” to the question “is this a rebuild of an existing course” 210, additional questions may be displayed by GUI 200 (“what percentage of the new course will use existing course content,” and “what percentage of the new course will be repurposed from existing content.”) These additional questions may not be displayed by GUI 200 in the event that the LC selects a “no” answer to the question “is this a rebuild of an existing course” 210.

GUI 200 may additionally include adjustment 214. Input cells in the same row as adjustment 214 may be used by the LC to increase or decrease hours calculated by column “analysis and design hours” 230 and column “solutions development hours” 232.

In GUI 200, column “analysis and design hours” 230 displays a numbers of hours that may be added by the learning estimation tool to obtain a total number of hours needed to create the learning solution. Column 230 also displays numbers of hours that may be subtracted from the total number of hours. Numbers of hours that may be subtracted are displayed in brackets. Additionally, in GUI 200, column “solutions development hours” 232 displays numbers of hours that may be added to obtain a total number of hours needed to design and develop the learning solution. Column 232 also displays numbers of hours that may be subtracted from the total number of hours. Numbers of hours that may be subtracted are displayed in brackets.

It should be noted that the hours included in columns 230 and 232 may be displayed by the learning estimation tool in response to answers selected or entered into GUI 200. One or more hours that are displayed in response to an input answer may be displayed in the same row as the input answer. For example, in GUI 200, the selection of the answer “HIGH” to question “what is the complexity of this component” 206 initiated the display of “240.00” hours in column 230 and “450.00” hours in column 232. Each of the hours displayed in columns 230 and 232 may be displayed in response to the receipt of an answer to a question displayed in the same row as the displayed hour(s).

It should be noted that, in the systems and methods of the invention, the hours displayed in response to a selected and/or an input answer may be predetermined. The learning estimation tool may include a lookup table, spread sheet, or any other database that includes a list of possible responses to each of the questions included in the learning estimation tool. The database may also associate with each of the possible responses a value of hours that will be displayed in each of columns “analysis and design hours” and “solutions development hours” in the event that the response is selected. The predetermined hours displayed in response to a selected answer may be associated with a level of difficulty, historical tabulations, associate research and/or any other suitable data associated with the selected answer. It should be noted that the value of hours associated with a response may be a positive number, negative number or a null value. It should additionally be noted that the value of the hours may correspond at least in part with a level of difficulty associated with the learning solution.

It should additionally be noted that, in some embodiments, the hours displayed in response to an answer associated with a first question may depend at least in part on an answer associated with a second question. For example, in GUI 200, the answer to question 206 initiated the display of “240.00” in column 230 and “450.00” in column 232. Additionally, in GUI 200, the answer “50%” to the question “what percentage of the new course will use existing course content” initiated the display of “(120.00)” in column 230 and “(225.00)” in column 232. Thus, the input of “50%” prompted the learning estimation tool to add the negative values “120” and “225” to columns 230 and 232, respectively, each of which represents 50% of the values “240” and “450” displayed in columns 230 and 232, respectively. These relationships may be stored in a database included in the learning estimation tool as equations, if-then sequences, or in any other suitable format.

GUI 200 may further include total A/D/D (Analysis, Design and Development) hours 220, project management hours 222 and average external development 224. GUI 200 may also include question “is analysis & design to be completed by internal or external resources” 216 and “is development to be completed by internal or external resources” 218. In exemplary GUI 200, the LC selected the answers “external” to questions 216 and 218

It should be noted that, in the systems and methods of the invention, “total A/D/D hours” may be calculated by summing the values included in the columns “analysis & design hours” and “solutions development hours.” It should additionally be noted that “project management hours” may be 20% of the “total A/D/D” value. Thus, the “project management hours” may be calculated by the equation: (project management hours)*(0.2). It should be noted that, while we have set forth the aforementioned exemplary algorithms to calculate total A/D/D hours and project management hours, any suitable algorithm may be used and is within the scope of the present invention.

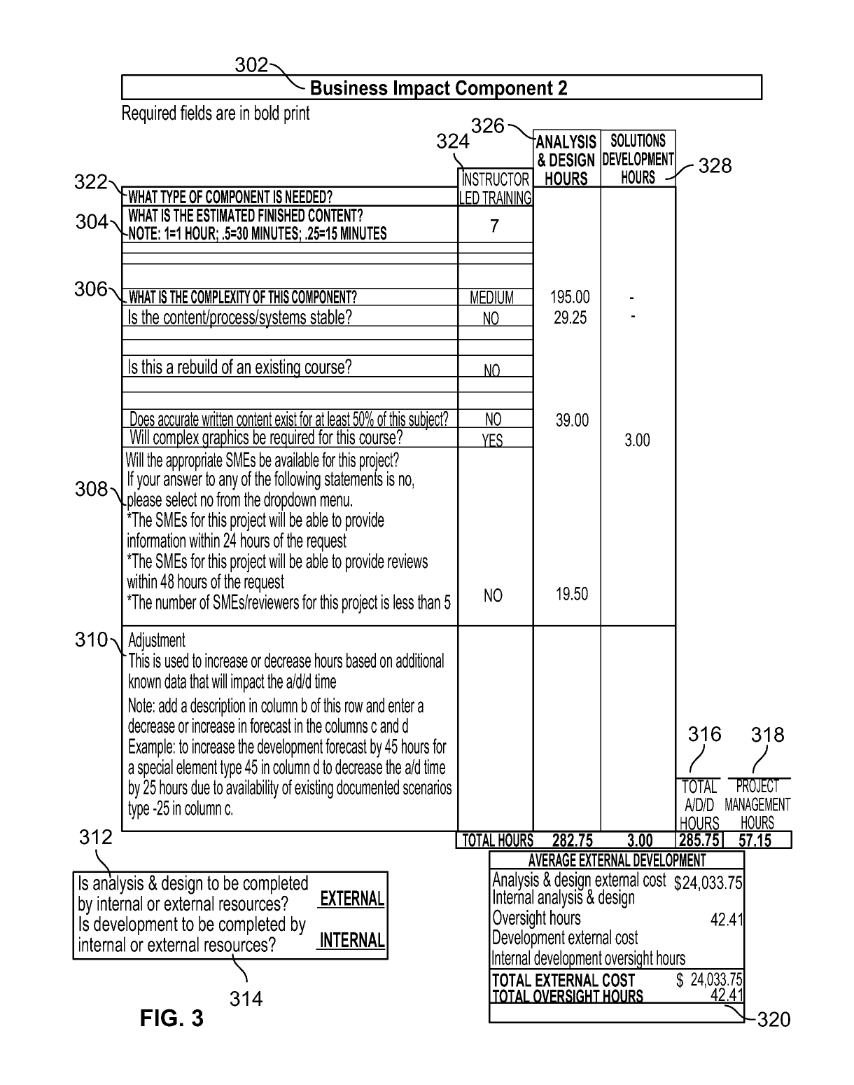

FIG. 3 shows another GUI that may be used in accordance with the systems and methods of the invention. The GUI displayed in FIG. 3 (referred to hereinafter as “GUI 300”) may be displayed in response to the selection of a BI Component Tab included in the learning estimation tool in accordance with the systems and methods of the invention.

GUI 300 may include header “Business Impact Component 2” 302. GUI 300 may additionally include question 322 “What Type of Component Is Needed?” Selectable input field 324 may include a drop-down list of multiple learning solutions that is displayed when input field 324 is selected. In GUI 300, a LC has selected the learning solution “Instructor Led Training” It should be noted that, upon selection of the learning solution, GUI 300 may subsequently display questions 304-308.

GUI 300 may display questions 304-308. These questions may include “what is the estimated finished content” 304, “what is the complexity of this component” 306 and “will the appropriate SMEs be available for the project” 308. GUI 300 may also display answers selected by the LC in response to questions 304-308. It should be noted that the answers may be selected from a drop-down list and/or manually input into GUI 300.

GUI 300 may additionally display adjustment 310. Input cells in the same row as adjustment 310 may be used by the LC to increase or decrease hours calculated by column “analysis and design hours” 326 and column “solutions development hours” 328.

Column “analysis and design hours” 326 may display numbers of hours that can be added to obtain a total number of hours needed to create the learning solution. Column 326 may also display numbers that can be subtracted from the total number of hours calculated. Numbers of hours that can be subtracted may be displayed in brackets. The hours included in column 326 may be displayed by the learning estimation tool in response to answers selected or entered into GUI 300.

Column “solutions development hours” 328 may display numbers of hours that can be added to obtain a total number of hours needed to design and develop the learning solution. The hours included in column 328 may be displayed by the learning estimation tool in response to answers selected or entered into GUI 300.

GUI 300 may further include total A/D/D hours 316, project management hours 318 and average external development 320. GUI 300 may also include question “is analysis & design to be completed by internal or external resources” 312 and “is development to be completed by internal or external resources” 314. In exemplary GUI 300, the LC selected the answer “external” to question 312 and the answer “internal” to question 314.

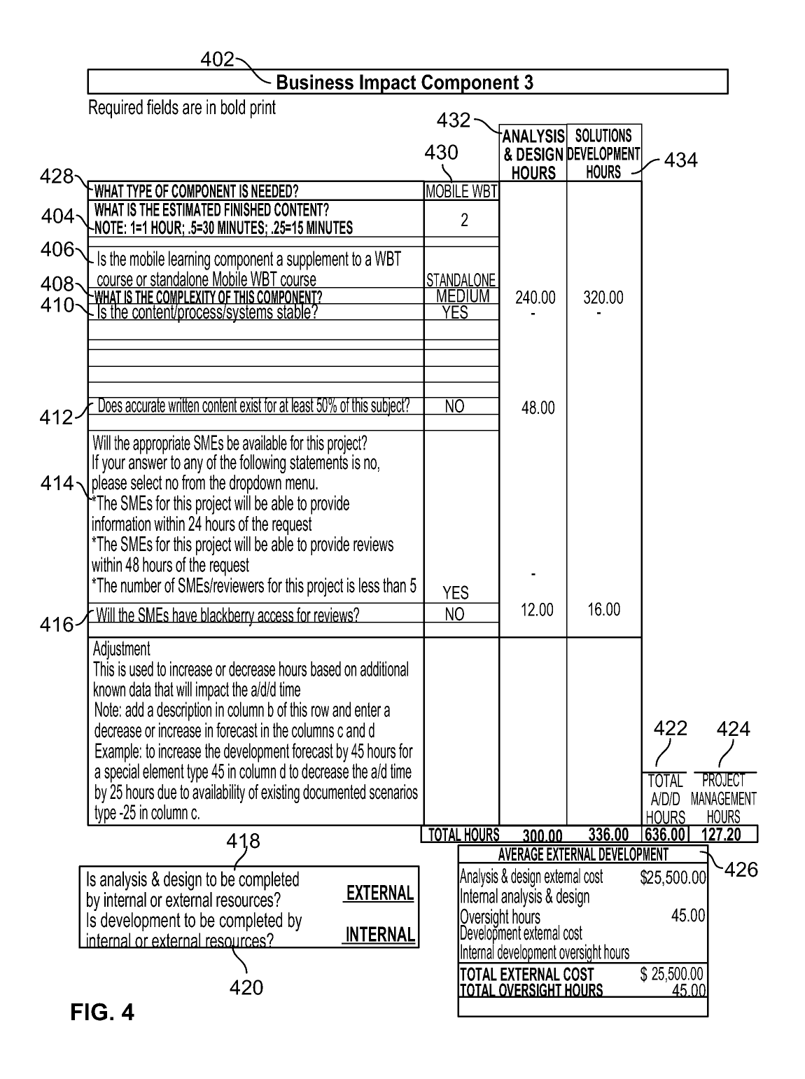

FIG. 4 shows yet another GUI that may be used in accordance with the systems and methods of the invention. The GUI displayed in FIG. 4 (referred to hereinafter as “GUI 400”) may be displayed in response to the selection of a BI Component Tab included in the learning estimation tool in accordance with the systems and methods of the invention.

GUI 400 may include header “Business Impact Component 3” 402. GUI 400 may additionally include question 428 “What Type of Component Is Needed?” Selectable input field 430 may include a drop-down list of multiple learning solutions that is displayed when input field 430 is selected. In GUI 400, a LC has selected the learning solution “Mobile WBT (Web-Based Training)” It should be noted that, upon selection of the learning solution, GUI 400 may subsequently display questions 404-416.

GUI 400 may display questions 404-416. Questions 404-416 may include “what is the estimated finished content” 404, “is the mobile learning component a supplement to a WBT course or standalone mobile WBT course” 406, “what is the complexity of this component” 408, “is the content/process/systems stable” 410, “does accurate written content exist for at least 50% of this subject” 412 and “will the appropriate SMEs be available for the project” 414. GUI 400 may also display answers selected by the LC in response to questions 404-416. It should be noted that the answers may be selected from a drop-down list and/or manually input into GUI 400.

GUI 400 may also include columns “analysis and design hours” 432 and “solutions development hours” 434. Column “analysis and design hours” 432 may display numbers of hours that will be added to obtain a total number of hours needed to create the learning solution. Column “solutions development hours” 434 may display numbers of hours that will be added to obtain a total number of hours needed to design and develop the learning solution. The hours included in columns 432 and 434 may be displayed by the learning estimation tool in response to answers selected or entered into GUI 400.

GUI 400 may further include total A/D/D hours 422, project management hours 424 and average external development 426. GUI 400 may also include question “is analysis & design to be completed by internal or external resources” 418 and “is development to be completed by internal or external resources” 420. In exemplary GUI 400, the LC selected the answer “external” to question 418 and the answer “internal” to question 420.

FIG. 5 shows yet another GUI that may be used in accordance with the systems and methods of the invention. The GUI displayed in FIG. 5 (referred to hereinafter as “GUI 500”) may be displayed in response to the selection of a BI Summary Tab included in the learning estimation tool in accordance with the systems and methods of the invention.

GUI 500 may include header “Estimation Wizard—Business Impact Component Blend Summary Page” 502. GUI 500 may additionally include input fields relating to Project Name 504 and Number of Associates to be Trained 506. An LC may input information into input fields 504 and 506.

GUI 500 may also include fields 508-540. Fields 508-540 may be automatically populated by the learning estimation tool based on information received and/or calculated by GUIs 200, 300 and 400. In the event that the LC changes information input into GUIs 200, 300 or 400, information displayed in one or more of fields 508-540 may be modified to reflect the changed information.

Fields 508-540 may include Internal Cost Per Associate 508, Supplier Cost Per Associate 510, Total Internal and Supplier Cost 512, Component 514, Internal Analysis & Design Hours 516, Internal Development Hours 518, Total Internal A/D/D Hours 520, Internal Project Management Hours 522, Analysis & Design 524, Development 526, Total Oversight Hours 528, Total Internal Hours 530, Audio Talent Cost 532, Analysis & Design 534, Development 536, Total External Cost 538 and Comments 540.

FIG. 6 shows an illustrative GUI that may be used in accordance with the systems and methods of the invention. The GUI displayed in FIG. 6 (referred to hereinafter as “GUI 600”) may be displayed in response to the selection of an Analysis Component Tab included in the learning estimation tool in accordance with the systems and methods of the invention.

GUI 600 may include header “Analysis Component 1” 602. GUI 600 may include questions 226 and 204-216. GUI 600 may additionally include answers to questions 226 and 204-216 displayed in column 610. The questions and answers initially displayed in GUI 600 may be substantially identical to the questions and answers displayed in GUI 200. It should be noted that both GUI 200 and GUI 600 relate to the learning solution “Instructional Website.”

An ID may subsequently select different answers to questions 226 and 204-216. It should be noted that the selection of different answers may generate GUI 600 to display additional questions and/or hide previously displayed questions. In the event that the ID selects different answers to questions 226 and 204-216, columns “analysis and design hours” 612 and column “solutions development hours” 614 may display a number of hours different from the number of hours displayed in columns 230 and 232. Additionally, values displayed in total A/D/D (Analysis, Design and Development) hours 604, project management hours 606 and average external development 608 may also be different from the values displayed in GUI 200.

GUI 600 may further include questions “is analysis & design to be completed by internal or external resources” 216 and “is development to be completed by internal or external resources” 218. It should be noted that the ID may select answers different from the answers selected by the LC in GUI 200.

Specifically, in GUI 600, the ID changed the answer to question “what is the complexity of this component” 206 from “HIGH” to “MEDIUM.” The changing of the answer to question 206 from “HIGH” to “MEDIUM” resulted in GUI displaying the number “175.00” in column 612 and “210.00” in column 614 instead of the numbers “240” and “450” initially imported from columns 230 and 232, respectively.

Additionally, in GUI 600, the ID changed the answer to the question “will American disability act requirements need to be considered” 208 from “NO” to “YES.” This modification prompted the learning estimation tool to display the value “8.75” in column 612 in place of the null value imported from column 230. Furthermore, in GUI 600, the ID changed the answer to the question “what percentage of the new course will be repurposed from existing content” 210 from “25%” to “20%.” This modification prompted the learning estimation tool to display the values “17.50” and “21.00” in columns 612 and 614, respectively, instead of the values “30.00” and “56.26” initially imported from columns 230 and 232, respectively.

It should be noted that the modification of the answers to questions 206, 208 and 210 prompts the learning estimation tool to calculate new values for total A/D/D hours 604, project management hours 606, and average external development 608.

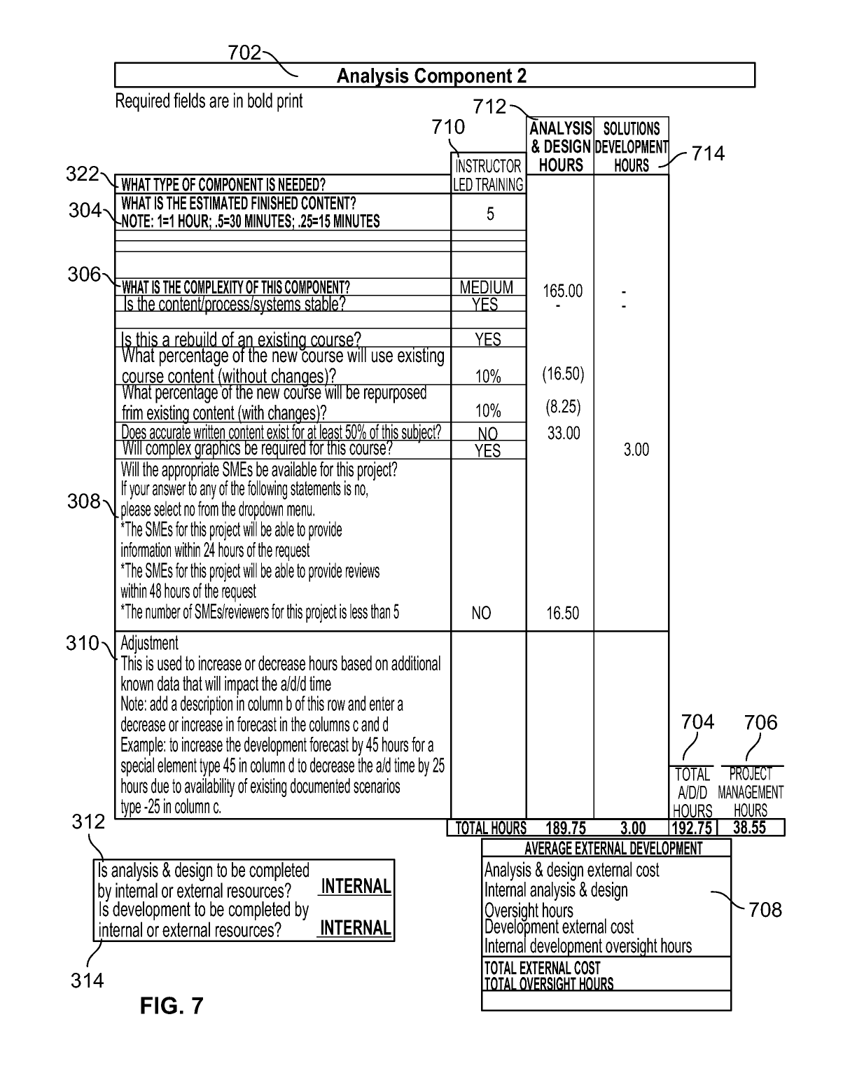

FIG. 7 shows an illustrative GUI that may be used in accordance with the systems and methods of the invention. The GUI displayed in FIG. 7 (referred to hereinafter as “GUI 700”) may be displayed in response to the selection of an Analysis Component Tab included in the learning estimation tool in accordance with the systems and methods of the invention.

GUI 700 may include header “Analysis Component 2” 702. GUI 700 may include questions 322 and 304-310. GUI 700 may additionally include answers to questions 322 and 304-310 displayed in column 710. The questions and answers initially displayed in GUI 700 may be substantially identical to the questions and answers displayed in GUI 300. It should be noted that both GUI 300 and GUI 700 relate to the learning solution “Instructor Led Training.”

An ID may subsequently select different answers to questions 322 and 304-310. It should be noted that the selection of different answers may generate GUI 700 to display additional questions and/or hide previously displayed questions. In the event that the ID selects different answers to questions 322 and 304-310, columns “analysis and design hours” 712 and column “solutions development hours” 714 may display a number of hours different from the number of hours displayed in columns 326 and 328. Additionally, values displayed in total A/D/D (Analysis, Design and Development) hours 704, project management hours 706 and average external development 708 may also be different from the values displayed in GUI 300.

GUI 700 may further include questions “is analysis & design to be completed by internal or external resources” 312 and “is development to be completed by internal or external resources” 314.

In GUI 700, the ID has made significant changes to the BI Component Tab associated with the learning solution “instructor led training.” Specifically, the ID has changed the answer to question “what is the estimated finished content” 322 from “7” to “5.” Additionally, the ID has changed the answer to the question “is the content/process/systems stable” from “no” to “yes.” Furthermore, the ID has changed the answer to the question “is this a rebuild of an existing course” from a “no” to a “yes.” The modification of the answers to these questions results in the GUI displaying additional questions relating to the stable content/process/system.

The modification of the answers prompts the values displayed in columns 712 and 714 to differ from the values originally imported from columns 326 and 328. Furthermore, total A/D/D hours 704 and project management hours 706 have been recalculated by the learning estimation tool to reflect the updated information.

In GUI 700, the ID also modifies the answer to question “is analysis & design to be completed by internal or external resources” 312 from “external” to “internal.” It should be noted that the selection of the answer “internal” to question 312 prompts the learning estimation tool to delete the costs associated with “analysis & design external cost” and “internal analysis & design oversight hours” that were previously imported from field 312. It should be further noted that the selection of the answer “internal” to question 314 by the LC in GUI 300 prompts the learning analysis solution to display no cost next to the “development external cost” and “internal development oversight hours” included in fields 320 and 708.

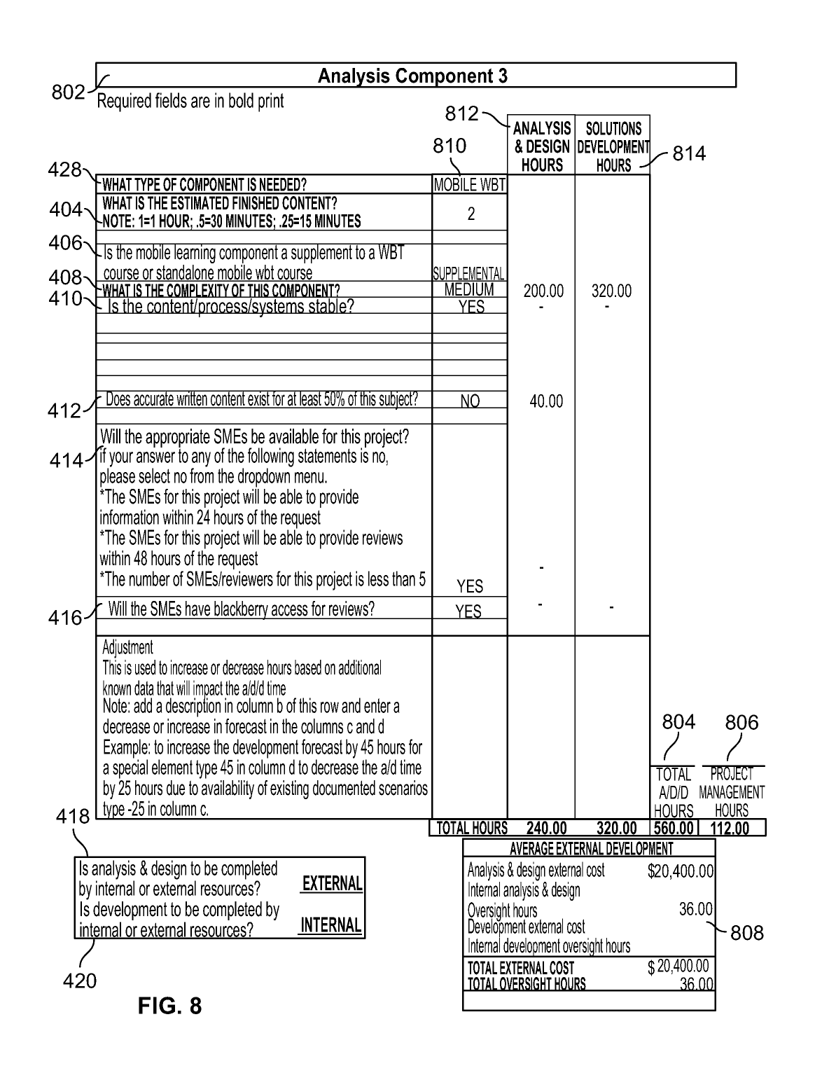

FIG. 8 shows an illustrative GUI that may be used in accordance with the systems and methods of the invention. The GUI displayed in FIG. 8 (referred to hereinafter as “GUI 800”) may be displayed in response to the selection of an Analysis Component Tab included in the learning estimation tool in accordance with the systems and methods of the invention.

GUI 800 may include header “Analysis Component 3” 802. GUI 800 may include questions 428 and 404-416. GUI 800 may additionally include answers to questions 428 and 404-416 displayed in column 810. The questions and answers initially displayed in GUI 800 may be substantially identical to the questions and answers displayed in GUI 400. It should be noted that both GUI 400 and GUI 800 relate to the learning solution “Mobile WBT.”

An ID may subsequently select different answers to questions 428 and 404-416. It should be noted that the selection of different answers may generate GUI 800 to display additional questions and/or hide previously displayed questions. In the event that the ID selects different answers to questions 428 and 404-416, columns “analysis and design hours” 812 and column “solutions development hours” 814 may display a number of hours different from the number of hours displayed in columns 426 and 428. Additionally, values displayed in total A/D/D (Analysis, Design and Development) hours 804, project management hours 806 and average external development 808 may differ from the values displayed in GUI 400.

GUI 800 may further include questions “is analysis & design to be completed by internal or external resources” 418 and “is development to be completed by internal or external resources” 420. It should be noted that the ID may select answers different from the answers selected by the LC in GUI 400.

Specifically, in GUI 800, the ID changes the answer to question “is the mobile learning component a supplement to a WBT course or standalone mobile WBT course” 406 from “standalone” to “supplemental.” The modification of the answer to question 406 results in the hours displayed in columns 812 and 814, in response to the answer “medium” to question 406, to differ from the hours displayed in GUI 400. Additionally, the ID changes the answer to the question “will the SMEs have blackberry access for reviews” 416 from “no” to “yes.” The modification of the answer to question 416 prompts the learning estimation tool to delete the values “12.00” and “16.00” from columns 812 and 814 that were initially generated to reflect the values included in GUI 400.

The modification of the answers to questions 406 and 416 prompts the learning estimation tool to calculate new values for total A/D/D hours 804, project management hours 806, and average external development 808.

FIG. 9 shows yet another GUI that may be used in accordance with the systems and methods of the invention. The GUI displayed in FIG. 9 (referred to hereinafter as “GUI 900”) may be displayed in response to the selection of an Analysis Summary Tab included in the learning estimation tool in accordance with the systems and methods of the invention.

GUI 900 may include header “Estimation Wizard—Analysis Component Blend Summary Page” 902. GUI 900 may also include input fields relating to Project Name 504 and Number of Associates to be Trained 506. GUI 900 may additionally include fields Internal Cost Per Associate 904, Supplier Cost Per Associate 506, Total Internal and Supplier Cost 908 and fields 514-540. Fields 904-908 and 514-540 may be initially automatically populated by the learning estimation tool based on information received and/or calculated by GUIs 600, 700 and 800. In the event that the ID changes information input into GUIs 600, 700 or 800, information displayed in one or more of fields 904-908 and 514-540 may be modified to reflect the changed information.

In exemplary GUIs 600, 700 and 800, the ID has changed a plurality of answers to questions that were initially imported from the BI Component Tabs, as discussed in detail above. Thus, GUI 900 reflects the modified values calculated by the Analysis Component Tabs in response to the received information. For example, although the “number of associates to be trained” 504 remains “450,” the “total internal and supplier cost” 908 has been calculated by the leaning analysis tool to be a value of “$66,656.50.” It should be noted that this value is significantly lower than the value “109,743.00” calculated by the learning estimation tool for GUI 500. Thus, the ID's input into the Analysis Component Tabs has significantly restructured a business's expected cost in designing and developing the learning strategies “instructional website,” “instructor led training” and “mobile WBT training” for a group of 450 high-level associates.

Thus, methods and apparatus for calculating the cost of designing and developing training for a group of business employees in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. Apparatus for determining a cost of designing and developing a teaching method to train a group of employees, the apparatus comprising:
a receiver configured to receive information relating to a first response selected from a first group of predetermined responses, the first group of predetermined responses relating to responses to a first question;
a processor configured to determine, based on the received first response, the amount of time necessary to design and develop the teaching method and to convert the amount of time into a dollar value;
the receiver being further configured to receive information relating to a second response selected from a second group of predetermined responses, the second group of predetermined responses relating to responses to a second question;
the processor being further configured to adjust, based on the received second response, the dollar value associated with the amount of time necessary to design and develop the teaching method.

2. The apparatus of claim 1, wherein the receiver is further configured to receive a selection of a selectable option, said selectable option for determining whether said teaching method is designed and developed using internal resources or external resources.

3. The apparatus of claim 1, wherein the processor is further configured to divide the amount of time necessary to design and develop the teaching method between analysis and design time and solution development time.

4. The apparatus of claim 3, wherein the processor is further configured to convert the analysis and design time into a separate dollar value.

5. The apparatus of claim 3, wherein the processor is further configured to convert the solution development time into a separate dollar value.

6. The apparatus of claim 1, wherein the processor is further configured to convert the analysis and design time and solution development time into a single dollar value.

7. The apparatus of claim 1, wherein the processor is further configured to calculate a project management amount of time based on the amount of time necessary to design and develop the teaching method.

8. One or more non-transitory computer-readable media storing computer-executable instructions which, when executed by a processor on a computer system, perform a method for projecting a cost of designing and developing a teaching method to train a group of employees, the method comprising:
using a receiver to receive information relating to a first response selected from a first group of predetermined responses, the first group of predetermined responses relating to responses to a first question;
using a processor to determine, based on the received first response, the amount of time necessary to design and develop the teaching method and to convert the amount of time into a dollar value;
using the receiver being further configured to receive information relating to a second response selected from a second group of predetermined responses, the second group of predetermined responses relating to responses to a second question;
using the processor to adjust, based on the received second response, the dollar value associated with the amount of time necessary to design and develop the teaching method.

9. The media of claim 8, further comprising using the receiver to receive a selection of a selectable option, said selectable option for determining whether said teaching method is designed and developed using internal resources or external resources.

10. The media of claim 8, further comprising using the processor to divide the amount of time necessary to design and develop the teaching method between analysis and design time and solution development time.

11. The media of claim 10, further comprising using the processor to convert the analysis and design time into a separate dollar value.

12. The media of claim 10, further comprising using the processor to convert the solution development time into a separate dollar value.

13. The media of claim 8, further comprising using the processor to convert the analysis and design time and solution development time into a single dollar value.

14. The media of claim 8, further comprising using processor to calculate a project management amount of time based on the amount of time necessary to design and develop the teaching method.
